(19) United States
(12) Patent Application Publication
(10) Pub. No.: US 2009/0252331 A1
(43) Pub. Date: Oct. 8, 2009

(54) METHOD OF SECURING TYPED CONVERSATION USING ENCRYPTION KEYS IN A VIRTUAL WORLD

(75) Inventor: Wolfgang G. Schadeberg, Chandlers Ford (GB)

Correspondence Address: IBM CORPORATION (ACCSP);c/o Suiter Swantz pc llo, 14301 FNB Parkway, Suite 220, Omaha, NE, 68154, US

(73) Assignee: INTERNATIONAL BUSINESS MACHINES CORPORATION, Armonk, NY (US)

(21) Appl. No.: 12/099,217

(22) Filed: Apr. 8, 2008

(51) Int. Cl. H04L 9/00

(52) U.S. Cl. 380/283

(57) ABSTRACT

The present invention is directed to a method of securing typed conversations using encryption keys when interfacing in a public environment established in a Virtual World, in a Massively Multiplayer Online Role-Playing Game (MMORPG).

### TECHNICAL FIELD

The present invention generally relates to the field of online gaming, and particularly to securing text based conversations in a massively multiplayer online role-playing game (MMORPG) and the like including other text based communication in a virtual environment.

### BACKGROUND

While using typed communication when in an environment that is outside of one's direct control there is a possibility that information communicated could be intercepted by a third party. This may be malicious but most likely would be inadvertent due to the nature of the environment. In some situations the release of the information could have troubling consequences and may cause disastrous results.

As an example, overhearing another's conversation while waiting at a bus stop could be likened to attending a gathering in one of the Virtual Worlds and overhearing two avatars communicating by watching their typed conversation.

Conversations in Virtual Worlds often contain information spoken in the belief that it is made anonymously, thus its contents may be of a subject not likely to be spoken openly. Such content might potentially be exploited and utilized to harm (from the perspective of the persons taking part in the conversation there may be serious consequences). Some examples may be business prospects, financial deals or personal information being discussed in the conversation.

Additionally to the chance of being overheard, these Virtual Worlds are often hosted or run by companies that are separate from their users. These Virtual Worlds are not part of a personal network or part of a company's intranet. The people using them have no idea of the intentions of the hosting organization at all. How the data is secured or who it is distributed to is out of the user's control completely. Whether the data is mined and sent onto advertising agencies or indeed sold to other businesses is usually unclear. The data is secured in a manner that is not controlled by or visible to the user. The user has no understanding of the risks associated with potential data loss as a result of the hosting company's actions.

### SUMMARY

Accordingly, the present invention is directed to a method of securing typed conversations using encryption keys when interfacing in a public environment established in a Virtual World, in for example, a Massively Multiplayer Online Role-Playing Game (MMORPG), such as WORLD OF WARCRAFT™, or in other similar person-to-person communication interfaces (hereinafter collectively called Virtual Worlds).

The present invention, in a presently preferred embodiment may be beneficially utilized in Virtual Worlds were text based communication may be stored or viewed either inside or outside a communicator's control. The present invention provides a system, method and apparatus capable of providing secure communication in public virtual space.

The present invention utilizes a unique key to provide an easy to use secure communication environment. Where implemented, the present invention may be set to block any text based communication which is not encrypted.

It is to be understood that both the forgoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

It is to be understood that both the foregoing general description and the following detailed description are exemplary and explanatory only and are not necessarily restrictive of the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

The numerous advantages of the disclosure may be better understood by those skilled in the art by reference to the accompanying figures in which:

FIG. 1 is a flow diagram illustrating a method for standard communication showing unidirectional unsecured information flow;

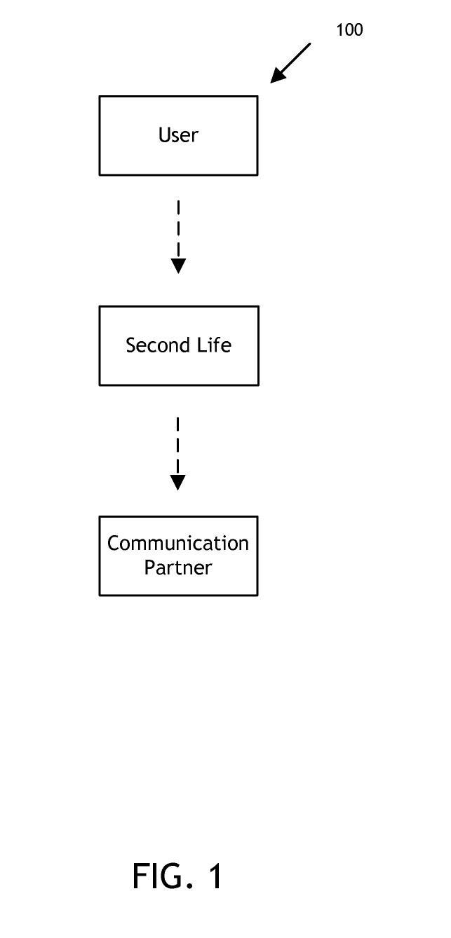

FIG. 2 is a flow diagram illustrating a method for a proposed solution for communication showing unidirectional secured information flow; and

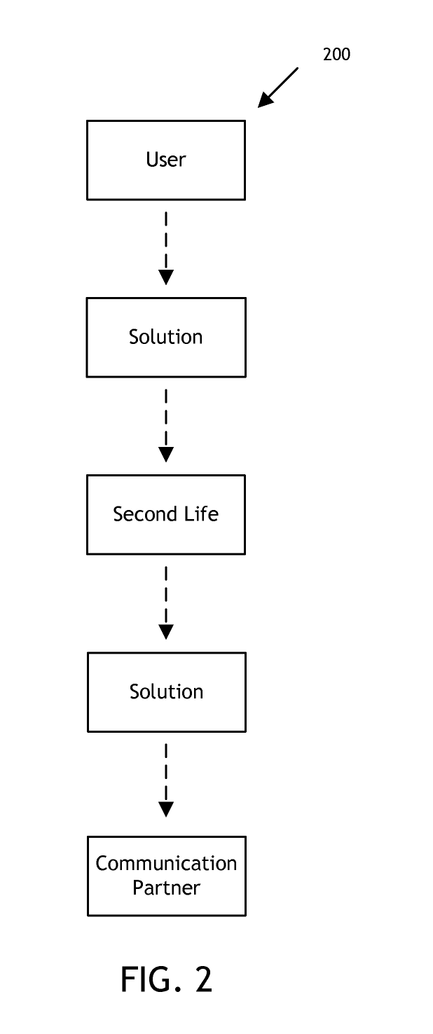

FIG. 3 is a flow diagram illustrating a presently preferred embodiment of the invention.

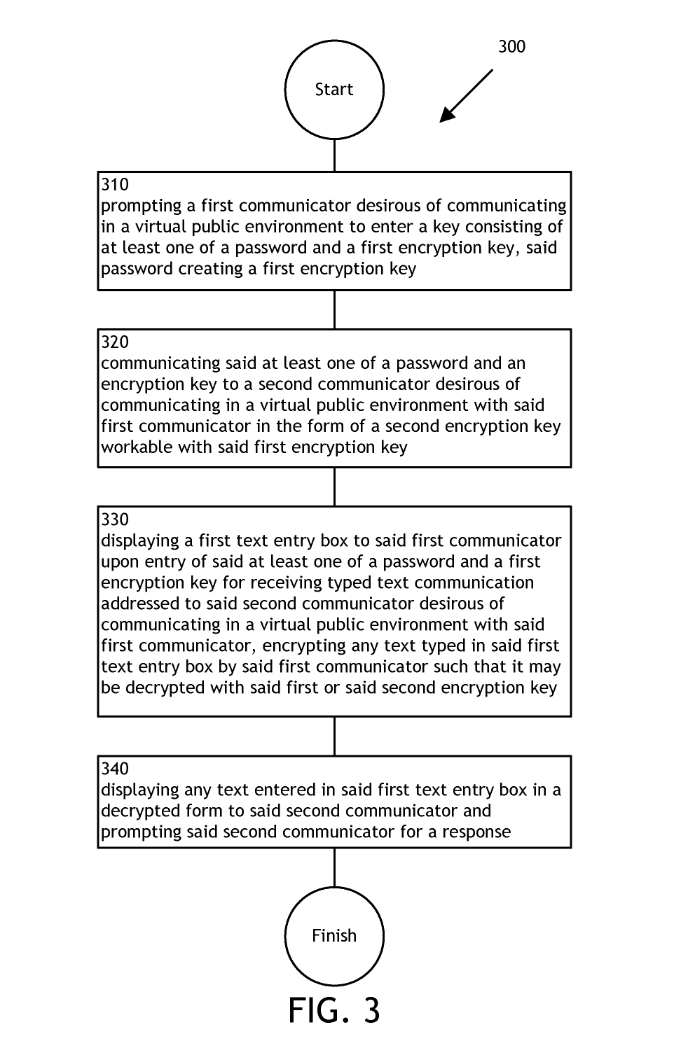

### DETAILED DESCRIPTION

Reference will now be made in detail to the subject matter disclosed, which is illustrated in the accompanying drawings.

In a preferred embodiment of a method of the present invention 100 allows a user to enter a preferably personalized unique control value(s). The invention then interfaces with a Virtual World's communication display encrypting and decrypting information so as to permit secure bidirectional information exchange.

In operation, the present invention, requests two encryption keywords and a decryption header. One encryption keyword is utilized to encrypt text and the other to decrypt text. These two keywords provide secure communication between the users. The decryption header would be used to identify which input text stream to apply the decryption to.

The system of the present invention may then prompt the user for their text communication which is then encrypted and passed to the communication screen being used in the Virtual World.

The system waits for a response in the same communication screen looking for the decryption header. Once found the response is decrypted and displayed to the user.

Further communication partners may be communicated with at the same time provided that their decryption keys are known.

In this fashion, any information available and stored in the public domain is now substantially secure.

The present invention 200 may be embodied as a computer program operably coupled with a computer running a MMORPG over a network connected preferably with at least one other computer running the same MMORPG. By way of example, in a MICROSOFT WINDOWS™ operating system operating in the Virtual World SECOND LIFE™. The present invention may also be configured to be beneficially employed in multiple operating systems and multiple Virtual Worlds.

Where the present invention 300 is deployed as a software program running on a general purpose computer and the like, the code would be unpacked and installed as per normal code installation procedures for the particular operating system. The product verification program may then run embedded help and refer to any tutorials.

It is then presently preferred that a user would request an encryption key 310 from the person being communicated with and provide that person with one of his or her own encryption keys. These keys would be transferred by a separate and secure method and not within SECOND LIFE™ itself (or the like). (The assumption here is that the communication partner is using the same software solution).

Once communication 320 is established within SECOND LIFE™ (or the like) between the user and the communication partner the solution would be activated. Further communication between these two would then operate via the present invention.

Communication with other communication partners may then be undertaken using the standard non-secure methods at the same time. In addition, standard non-secure communication may also take place with the original communication partner. A user may choose which information to encrypt.

Additionally, the present invention may create a separate window 330 into which the user may type plain text messages. The system encrypts the plain text and programmatically injects the resultant cipher text into the actual communication system used by the public environment interaction software (e.g. SECOND LIFE™).

This ensure that the cipher text is actually acceptable to the interaction software's communication channel. Most cryptographic algorithms produce binary cipher text containing non-typeable characters, whereas the interaction software would presumably be expecting only data that could be typed on a keyboard. The present invention may then assign any non-acceptable cipher text characters 340 a unique acceptable typeable character set.

The system may utilize separate keys for encryption and decryption. (One encryption keyword may be used to encrypt text and the other to decrypt text.) In symmetric encryption technologies, the same key is used both to encrypt and decrypt. In asymmetric (public key) encryption, a related pair of keys (public and private) is used: the public key is used at one end of the communication system and the private key at the other. The present invention may be adapted to utilize any of these key systems.

The solution proposed would generate encrypted text that would be textual in nature. No binary data would need to be transferred. The cipher routine would only produce and read text that can be generated by using a standard keyboard. The key usage would be asymmetric with two related keys being used. The keys suggested might be works or phrases and can be transferred in person, via email, or using a telephone. In more complex situations, the parties involved may use a common book and simply transfer the pages and word numbers, rather than the words involved. (There are many other possibilities.)

In many cases users of these virtual worlds only have control of their own personal computer and are unable to guarantee any degree of security. In some cases the cost of encryption being built into the underlying technology is beyond the user. This application provides assurance that the data leaving their controlled computers and environment is encrypted.

In the present disclosure, the methods disclosed may be implemented as sets of instructions or software readable by a device. Further, it is understood that the specific order or hierarchy of steps in the methods disclosed are examples of exemplary approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

1. A method for securing typed conversations in a virtual public environment, comprising:
prompting a first communicator desirous of communicating in a virtual public environment to enter a key consisting of at least one of a password and a first encryption key, said first encryption key created from said password;
communicating said at least one of a password and a first encryption key to a second communicator desirous of communicating in a virtual public environment with said first communicator in a form of a second encryption key configured to communicate with said first encryption key, said at least one of a password and said first encryption key being communicated through a software solution separate from said virtual public environment, said software solution common to said first communicator and said second communicator;
displaying a first text entry box to said first communicator upon entry of said at least one of a password and a first encryption key for receiving typed text communication addressed to said second communicator desirous of communicating in a virtual public environment with said first communicator, encrypting any text typed in said first text entry box by said first communicator such that it may be decrypted with said first or said second encryption key; and
displaying any text entered in said first text entry box in a decrypted form to said second communicator and prompting said second communicator for a response.
